(19) United States
(12) Patent Application Publication
(10) Pub. No.: US 2024/0125334 A1
(43) Pub. Date: Apr. 18, 2024

(54) AIR COMPRESSOR

(71) Applicant: Hanon Systems, Daejeon (KR)

(72) Inventors: Kyu Sung CHOI, Daejeon (KR); Hyun Chil KIM, Daejeon (KR); Gun Woong PARK, Daejeon (KR); Min Gyu PARK, Daejeon (KR); Chi Yong PARK, Daejeon (KR); Yeol Woo SUNG, Daejeon (KR); Hyun Sup YANG, Daejeon (KR); Jong Sung LEE, Daejeon (KR)

(21) Appl. No.: 18/276,668

(22) PCT Filed: Mar. 30, 2022
(86) PCT No.: PCT/KR2022/004534

§ 371 Date: Aug. 10, 2023

(30) Foreign Application Priority Data
Apr. 12, 2021 (KR) 10-2021-0047422
Feb. 8, 2022 (KR) 10-2022-0016032

(51) Int. Cl. F04D 29/58

(52) U.S. Cl. CPC F04D 29/5806; F04D 29/5813; F04D 29/5826; F04D 17/10

(57) ABSTRACT

An air compressor according to an aspect of the present invention comprises: a housing; a rotating shaft which is disposed in the housing; a compression unit which is connected to the rotating shaft to compress and discharge inlet air; a motor unit which drives the rotating shaft; a control board which controls the motor unit; and a filter unit which filters out noise from external power and supplies the external power to the control board, wherein the housing includes a first cooling flow channel for cooling the motor unit and a second cooling flow channel for cooling the filter unit, and the first cooling flow channel communicates with the second cooling flow channel.

### TECHNICAL FIELD

The present invention relates to an air compressor, and more particularly, to an air compressor integrally provided with a control unit.

### BACKGROUND ART

Generally, a fuel cell vehicle is a vehicle in which hydrogen and oxygen are supplied to a humidifier and electrical energy generated by an electrochemical reaction which is an electrolysis reverse reaction of water is supplied as driving force of the vehicle. A typical fuel cell vehicle was proposed in Korean Patent Registration No. 0962903.

Typically, fuel cell sedans are provided with an 80-kW fuel cell stack. In the case where a fuel cell stack is operated under pressurization conditions, high-pressure air ranging from 1.2 bar to 3.0 bar is supplied to the fuel cell stack. To this end, an air compressor which is operated at a speed of 5,000 rpm to 100,000 rpm is required to be used.

Fuel cell vehicles generally include a fuel cell stack configured to generate electricity, a humidifier configured to humidify fuel and air to be supplied to the fuel cell stack, a fuel supply unit configured to supply hydrogen to the humidifier, an air supply unit configured to supply air including oxygen to the humidifier, a cooling module configured to cool the fuel cell stack, and so forth.

The air supply unit includes an air cleaner configured to filter out foreign substances included in air, an air compressor configured to compress and supply air filtered by the air cleaner, and a control box configured to control the air compressor.

The above-mentioned air compressor compresses air sucked from the outside using an impeller and then discharges the compressed air to the fuel cell stack through a discharge port. In this case, the impeller and the shaft constituting the compression unit are driven by the rotational force of the motor.

The inverter supplies electric power to a motor of such an air compressor and controls the operation of the motor. The inverter includes a Printed Circuit Board (PCB) on which transistors, capacitors, inductors, and electrical components such as constant resistors, diodes, and drivers are mounted.

However, the inside of the conventional air compressor is overheated due to heat generated by the motor and the inverter. In addition, there is a problem in that a separate space for providing a cooling means is required and the size of the air compressor increases.

### DISCLOSURE

### Technical Problem

The present invention has been devised to solve the problems described above, and an object thereof is to provide an air compressor with increased internal heat exchange efficiency and improved space utilization of a cooling means.

The object to be solved by the present invention is not limited to the above object, and other objects described above will be clearly understood by those skilled in the art from the following description.

### Technical Solution

An air compressor according to one aspect of the present invention may comprise a housing; a rotating shaft disposed inside the housing; a compression unit that is connected to the rotating shaft and compresses and discharges introduced air; a motor unit that drives the rotating shaft; a control board that controls the motor unit; and a filter unit that filters noise of external power and supplies the external power to the control board, wherein the housing may include a first cooling flow channel for cooling the motor unit and a second cooling flow channel for cooling the filter unit, and the first cooling flow channel communicates with the second cooling flow channel.

Preferably, the first cooling flow channel may be disposed in an axial direction of the motor unit.

Preferably, the first cooling flow channel may be provided in plurality.

Preferably, the plurality of first cooling flow channels may be connected through a connection passage, the connection passage may be disposed so that a heat exchange medium moving in the first cooling flow channel moves in a zigzag pattern.

Preferably, the second cooling flow channel may be disposed along a radial direction of the motor unit.

Preferably, the second cooling flow channel may perform heat exchange with a configuration of the filter unit.

Preferably, the second cooling flow channel may be disposed inside a heat exchanger.

Preferably, heat exchange may be performed on at least one surface of the heat exchanger.

Preferably, the second cooling flow channel may be disposed behind the motor unit.

Preferably, the first cooling flow channel and the second cooling flow channel may be connected in series.

Preferably, areas of the second cooling flow channel and first cooling flow channel may be respectively disposed on upper and lower portions of the filter unit.

Preferably, the filter unit may include a transistor, and the heat exchanger may perform heat exchange with the transistor.

Preferably, the second cooling flow channel may include a second-1 cooling flow channel and a second-2 cooling flow channel.

Preferably, the second-1 cooling flow channel may be disposed on an upper portion of the filter unit, and the second-2 cooling flow channel may be disposed on a lower portion of the filter unit.

Preferably, one side of the heat exchanger may perform heat exchange with the filter unit, and the other side of the heat exchange may perform heat exchange with the motor unit.

Preferably, the heat exchanger may include a first heat exchange passage in which the second-1 cooling flow channel is disposed and a second heat exchange passage in which the second-2 cooling flow channel is disposed.

Preferably, the housing may include an impeller housing and a drive housing, the motor unit may be disposed in the driving housing, accommodating units may be formed on both sides of an upper portion of the motor unit, and the filter unit may be disposed in the accommodating units.

Preferably, at least one of the accommodating units may be connected to a connector unit.

Preferably, the motor unit may include a rotor disposed outside the rotating shaft and a stator disposed on outside the rotating shaft, the stator may include teeth and a shoe disposed at ends of the teeth, at an end of the shoe facing the rotor, a groove may be disposed to be biased from a center line of the teeth.

Preferably, the air compressor may comprise a cooling cover disposed on the heat exchanger, wherein the cooling cover and the heat exchanger may be integrally provided.

### Advantageous Effects

According to embodiments, it is possible to improve the arrangement relationship between the cooling flow channel and the filter unit to increase internal heat exchange efficiency and reduce the size of the air compressor.

Various useful advantages and effects of the present invention are not limited to the foregoing and can be more readily understood while specific embodiments of the present invention are described.

### BRIEF DESCRIPTION OF THE DRAWINGS

FIG. 1 is a schematic cross-sectional view of an air compressor according to an embodiment of the present invention.

FIG. 2 is a plan view of a housing and a filter unit according to an embodiment of the present invention.

FIG. 3 is a partial cross-sectional view of an air compressor according to an embodiment of the present invention.

FIG. 4 is a partial cross-sectional view of an air compressor according to an embodiment of the present invention.

FIG. 5 is a plan view of a housing according to an embodiment of the present invention.

FIG. 6 is a partial cross-sectional view of a front portion of an air compressor according to an embodiment of the present invention.

FIG. 7 is a partial cross-sectional view of a front portion of an air compressor according to an embodiment of the present invention.

FIG. 8 is a view showing the positions of a first cooling flow channel and second cooling flow channel in a housing according to an embodiment of the present invention.

FIG. 9 is a view showing the shape of the first cooling flow channel in FIG. 8.

FIG. 10 is a view showing the inflow and outflow structure of the heat exchanging medium in FIG. 1.

FIG. 11 is a view showing the internal structure of FIG. 1.

FIG. 12 is a view showing a first embodiment of the cooling flow channel in FIG. 1.

FIG. 13 is a view showing the flow of the heat exchanging medium in FIG. 12.

FIG. 14 is a view showing a second embodiment of the cooling flow channel in FIG. 1.

FIG. 15 is a view showing the flow of the heat exchanging medium in FIG. 14.

FIG. 16 is a perspective view of a cover according to an embodiment of the present invention.

### MODE FOR INVENTION

Hereinafter, preferred embodiments of the present invention will be described in detail with reference to the accompanying drawings.

However, the technical spirit of the present invention is not limited to some embodiments to be described and may be implemented using various other embodiments, and one or more components of the embodiments may be selectively coupled, replaced, and used within the technical spirit of the present invention.

In addition, unless the context clearly defines and is specifically defined, terms (including technical and scientific terms) used herein may be interpreted to have meanings commonly understood by those skilled in the art, and meanings of commonly used terms such as terms defined in dictionaries will be interpreted as contemplating the context of the relevant art.

Furthermore, the terminology used in the embodiments of the invention is to be regarded as illustrative only and is not limiting of the invention.

In this specification, unless the context clearly indicates otherwise, the singular form includes the plural form, and where “at least one (or one or more) of A, B and C” is described, this may include at least one of all possible combinations of A, B and C.

Further, in the description of the components of the present invention, terms such as “first”, “second”, “A”, “B”, “(a)”, and “(b)” may be used.

The terms are used merely to distinguish one element from another element, and the nature, order, etc. of the elements are not limited to these terms.

Furthermore, when an element is referred to as being “connected,” “coupled,” or “linked” to another element, such description can include instances where the element is directly connected or coupled to the other element as well as instances where the element is connected, coupled, or linked to the other element with the other element disposed therebetween.

In addition, when any one element is described as being formed or disposed “upper (on)” or “lower (under)” another element, such description includes both the case where two elements are formed or disposed in direct contact with each other and the case where one or more other elements are interposed between the two elements. In addition, when an element is described as being formed “upper (on) or lower (under)” another element, such description may include the case where the element is formed on the upper side or the lower side with respect to the other element.

Hereinafter, embodiments will be described in detail with reference to the drawings, and components identical to or corresponding to each other will be denoted by the same reference numerals in all drawings, and redundant description will be omitted.

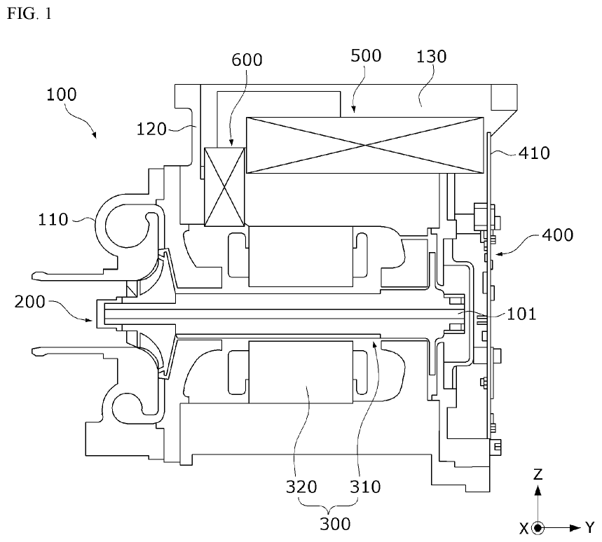

In FIGS. 1 to 16, only major parts are clearly shown for a conceptual clear understanding of the present invention, and thus, various changes of the drawings are contemplated, and it is not necessary that the scope of the present invention be limited by the specific shapes shown in the drawings.

FIG. 1 is a schematic cross-sectional view of an air compressor according to an embodiment of the present invention.

Referring to FIG. 1, an air compressor may include a housing 100, a compression unit 200, a motor unit 300, a control board 410, a filter unit 500, and a bus bar assembly 600.

The housing 100 constitutes the outside, and a rotating shaft 101, the compression unit 200, and the motor unit 300 are disposed in the housing 100. The housing 100 may include an impeller housing 110 and a drive housing 120.

An inlet hole and an outlet may be provided in the impeller housing 110. In addition, the compression unit 200 is disposed in the inner space of the impeller housing 110. In this case, the air introduced through the inlet hole is compressed by the compression unit 200 and discharged to the outside through the discharge port.

The drive housing 120 is connected to the rear end of the impeller housing 110. Here, the rear side is disposed in a direction from the compression unit 200 toward the motor unit 300, and the front side is disposed in a direction opposite to the direction toward the rear side. In this case, the motor unit 300 is disposed in the inner space of the driving housing 120. In addition, a cooling flow channel may be formed inside the driving housing 120.

The compression unit 200 is disposed at the front side in the housing 100.

The motor unit 300 is used to rotationally drive the rotating shaft 101 to supply driving force to the compression unit 200. In this case, the motor unit 300 may include a rotor 310 and a stator 320. The stator 320 may include a driving coil. The driving coil generates electromagnetic force when power is supplied from the outside. Accordingly, the rotor 310 may rotate due to electromagnetic interaction between the rotor 310 and the stator 320. Meanwhile, one side of the rotor 310 is connected to the compression unit 200 to drive the compression unit 200. In this case, the driving coil may be operated by receiving three-phase alternating current power.

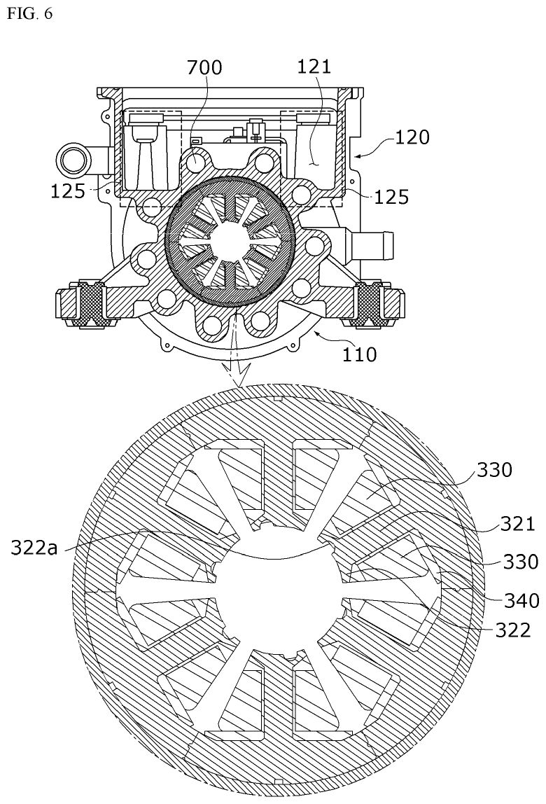

Referring to FIGS. 1 and 6, the stator 320 of the motor unit 300 is disposed on an outer surface of the rotor 310. A driving coil 330 is disposed to be wound on an outer surface of teeth 321 provided on the stator 320. An insulator 340 may be disposed between the teeth 321 and the driving coil 330.

In this case, the end of the teeth 321 is disposed on the circumference to face the rotor 310. A shoe 322 is disposed at an end of the teeth 321 facing the rotor 310.

In this case, a groove 322a may be formed at an end of the shoe 322. The groove 322a may prevent magnetic flux from being concentrated into the teeth 321 of the stator 320 when the rotor 310 rotates.

In one embodiment, the groove 322a may be arranged to deviate from the center line of the teeth 321.

The circuits and elements for controlling the motor unit 300 are mounted on the control board 410. In this case, the control board 410 may be a Printed Circuit Board (PCB). The control board 410 may be disposed on the rear side of the rotating shaft 101 and the motor unit 300, and may be spaced apart from the rear end of the rotating shaft 101. The control board 410 is formed in the shape of a board. The thickness direction of the control board 410 may be disposed to face the axial direction of the rotating shaft 101.

The filter unit 500 receives external power and supplies the external power to the control board 410. The filter unit 500 supplies the external power to the control board 410 in a state where noise of the power is removed. In this case, the filter unit 500 may be disposed outside the motor unit 300 in the radial direction.

The bus bar assembly 600 transmits the power of the control board 410 to the motor unit 300. In this case, the power may be transmitted to the motor unit 300 through the filter unit 500 and the bus bar assembly 600. The bus bar assembly 600 may transmit the three-phase AC voltage converted by the filter unit 500 to the motor unit 300.

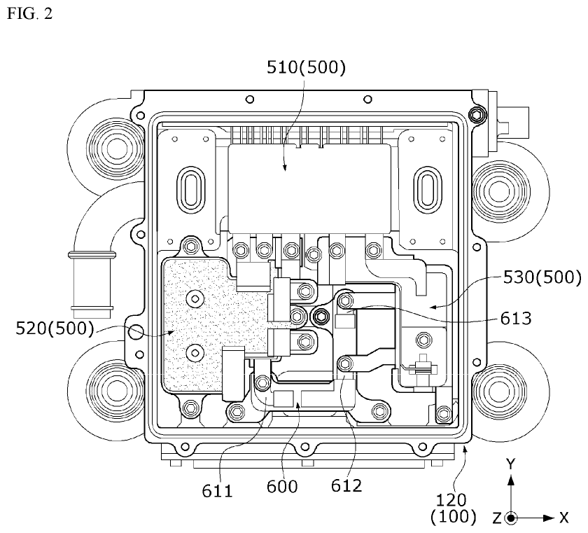

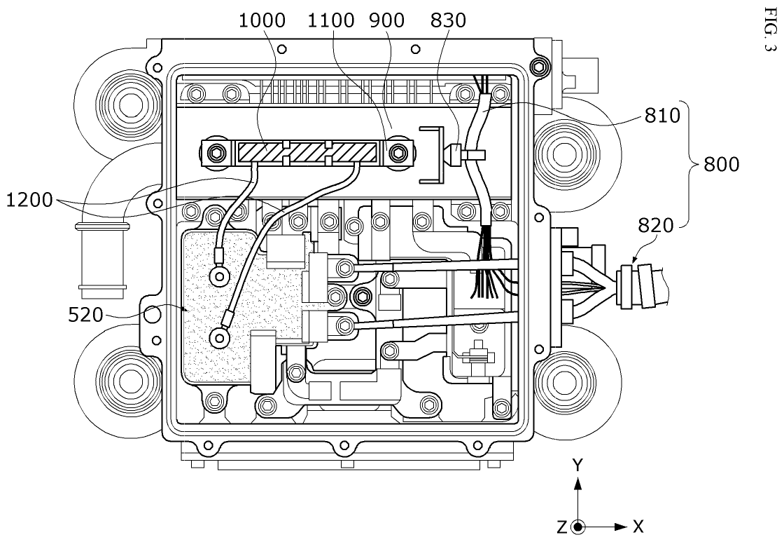

FIG. 2 is a plan view of a housing and a filter unit according to an embodiment of the present invention, and FIG. 3 is a partial cross-sectional view of an air compressor according to an embodiment of the present invention.

Referring to FIGS. 2 and 3, the driving housing 120 has a space in which the compression unit 200 and the motor unit 300 are disposed. Also, the driving housing 120 may form a filter accommodating unit 130 in which the filter unit 500 is disposed.

The filter unit 500 may include a transistor 510, a capacitor assembly 520 and a current sensor assembly 530.

The transistor 510 converts a Direct Current (DC) voltage into a driving voltage of the motor unit 300 through a switching operation. The transistor 510 is disposed behind the filter accommodating unit 130 and is connected to the control board 410. In this case, the transistor 510 may be an Insulated Gate Bipolar Transistor (IGBT).

The transistor 510 includes six IGBTs including a first phase (phase U) high switching element, a first phase (phase U) low switching element, a second phase (phase V) high switching element, a second phase (phase V) low switching element, a third phase (phase W) high switching element, and a third phase (phase W) low switching element. The transistor 510 is connected to a capacitor assembly 520 and a current sensor assembly 530.

The capacitor assembly 520 is electrically connected to an external power source and receives and stores high voltage DC current. In addition, the capacitor assembly 520 is electrically connected to the transistor 510 and the bus bar assembly 600.

The current sensor assembly 530 detects a current transmitted to the motor unit 300. The current sensor assembly 530 is electrically connected to the transistor 510 and the bus bar assembly 600.

The transistor 510, capacitor assembly 520, and current sensor assembly 530 may be mounted on the filter accommodating unit 130. In this case, the capacitor assembly 520 and the current sensor assembly 530 may be disposed in a first direction (X-axis direction). In addition, the transistor 510 may be disposed in a second direction (Y-axis direction) with respect to the capacitor assembly 520 and the current sensor assembly 530. In this case, the first direction (X-axis direction) and the second direction (Y-axis direction) may be perpendicular to each other, and the second direction (Y-axis direction) may be parallel to the axial direction.

The bus bar assembly 600 connects the motor unit 300 and the filter unit 500. The bus bar assembly 600 transfers power from the control board 410 to the motor unit 300. In this case, the bus bar assembly 600 may be electrically connected to the capacitor assembly 520 and the current sensor assembly 530. The bus bar assembly 600 includes a plurality of bus bars, at least one of the plurality of bus bars may be connected to the capacitor assembly 520, and at least one of the plurality of bus bars may be connected to the current sensor assembly 530.

The bus bar assembly 600 may be spaced apart from the transistor 510 in the second direction (Y-axis direction) with the capacitor assembly 520 and the current sensor assembly 530 interposed therebetween. In this case, the bus bar assembly 600 may be connected to the motor unit 300 by passing through the filter accommodating unit 130.

A through hole 120H in which the bus bar assembly 600 is disposed may be formed in the drive housing 120. The bus bar assembly 600 may have one end connected to the motor unit 300 and the other end connected to the filter unit 500 based on the through hole 120H.

The air compressor having the above structure minimizes the thickness of the housing between the motor unit 300 and the filter unit 500 and compactly arranges the parts of the filter unit 500 in the filter accommodating unit 130, thereby reducing the size of the air compressor.

The bus bar assembly 600 may include a bus bar 610 and a bus bar fixing member 620.

The bus bar 610 is electrically connected to the motor unit 300. In this case, the bus bar 610 supplies the AC voltage converted by the transistor 510 to the motor unit 300. The bus bar 610 may be provided as a plurality of bus bars 610. The plurality of bus bars 610 may include a U-phase bus bar 611 transmitting AC power of a first phase (phase U), a V-phase bus bar 612 transmitting AC power of a second phase (phase V), and a W-phase bus bar 613 transmitting AC power of a third phase (phase W).

The plurality of bus bars 610 may extend outward from the motor unit 300 in a radial direction. In addition, the bus bar 610 may pass through the through hole 120H and may be bent toward the filter unit 500. In this case, the U-phase bus bar 611 may be bent toward the capacitor assembly 520, and the V-phase bus bar 612 and W-phase bus bar 613 may be bent toward the current sensor assembly 530.

The ends of the U-phase bus bar 611, the V-phase bus bar 612, and the W-phase bus bar 613 may be exposed from the bus bar fixing member 620 in a state in which the ends are spaced apart from each other. In this case, an end of at least one of the plurality of bus bars 610 may be connected to the capacitor assembly 520, and the remaining bus bars of the plurality of bus bars 610 may be connected to the current sensor assembly 530.

According to embodiments, since the ends of the bus bar 610 are provided to branch in two directions, an assembly space can be secured between the bus bar 610, the capacitor assembly 520, and the current sensor assembly 530, and thus assembly convenience can be improved.

The bus bar fixing member 620 fixes the plurality of bus bars 610 to the housing 100 in a state where the plurality of bus bars 610 are insulated. To this end, the bus bar fixing member 620 may include a grommet 621 and a guide member 622.

The grommet 621 is provided in through-hole 120H, and fixes the plurality of bus bars 610 passing through-hole 120H. In this case, the grommet 621 may have elasticity and may be formed of an insulating material. Preferably, the grommet 621 may be formed of a rubber material.

The guide member 612 fixes at least portion of the plurality of bus bars 610 to the mounting surface 121. In this case, the guide member 612 may guide each end of the plurality of bus bars 610 to the capacitor assembly 520 or the current sensor assembly 530. The guide member 612 may be formed of an insulating material. Preferably, the guide member 612 may be formed of a plastic material.

According to embodiments, the air compressor according to the present invention includes a plurality of cooling flow channels 700 that cool the motor unit 300. The plurality of cooling flow channels 700 may extend parallel to an axial direction of the rotating shaft (101 in FIG. 1). The plurality of cooling flow channels 700 may be embedded in the housing 100 and disposed between the motor unit 300 and the filter unit 500. In this case, the plurality of cooling flow channels 700 may be disposed to be spaced apart from each other in the circumferential direction of the motor unit 300 to surround at least one side of the motor unit 300 and may absorb heat generated by the motor unit 300.

Referring to FIG. 3, the air compressor according to the present invention may include a connector unit 800, a cooling cover 900, a discharge resistor 1000, a first fixing member 1100, and a connecting member 1200.

The connector unit 800 may apply external power to the filter unit 500 and transmit a signal detected by the filter unit 500 to the control board 410. The connector unit 800 may include a first connector 810 and a second connector 820.

The first connector 810 electrically connects the control board 410 and the current sensor assembly 530. In addition, a portion of the first connector 810 is connected to the second connector 820 to check whether the capacitor assembly 520 and the second connector 820 are connected.

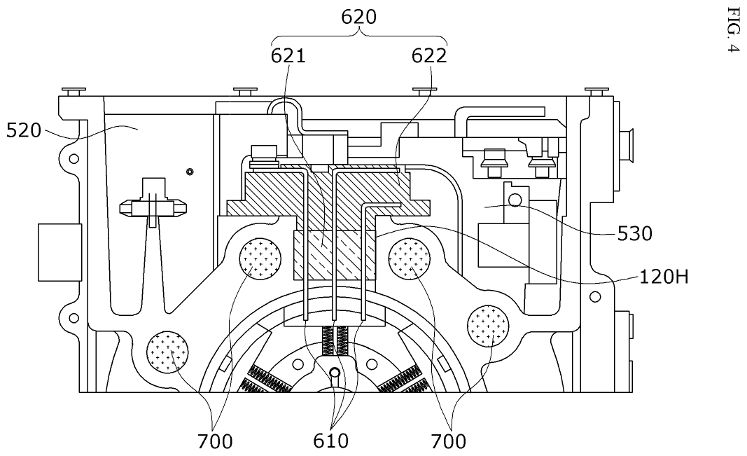

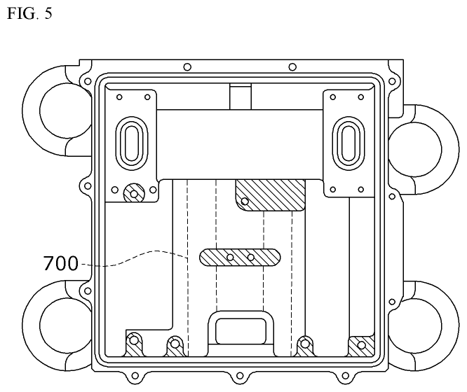

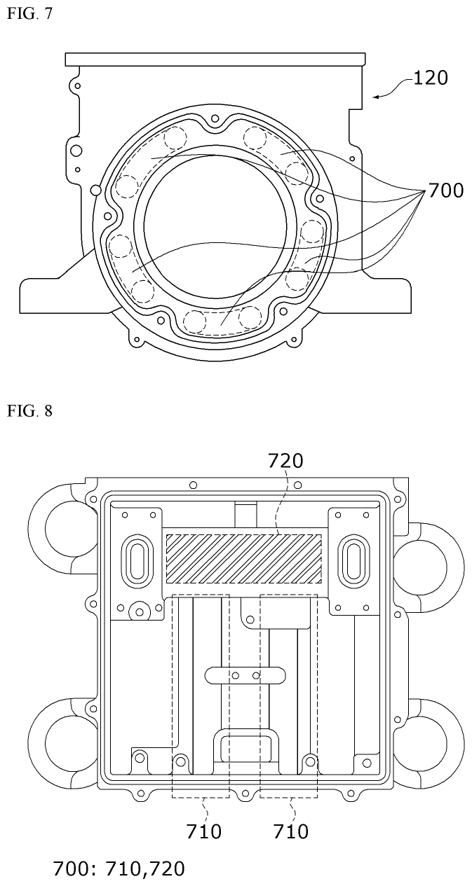

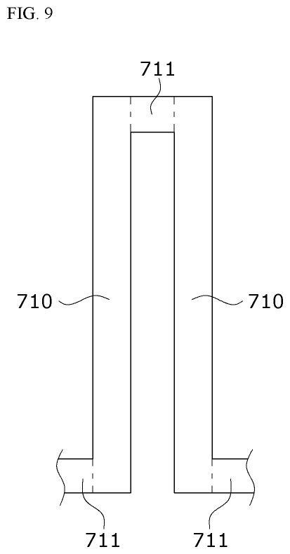

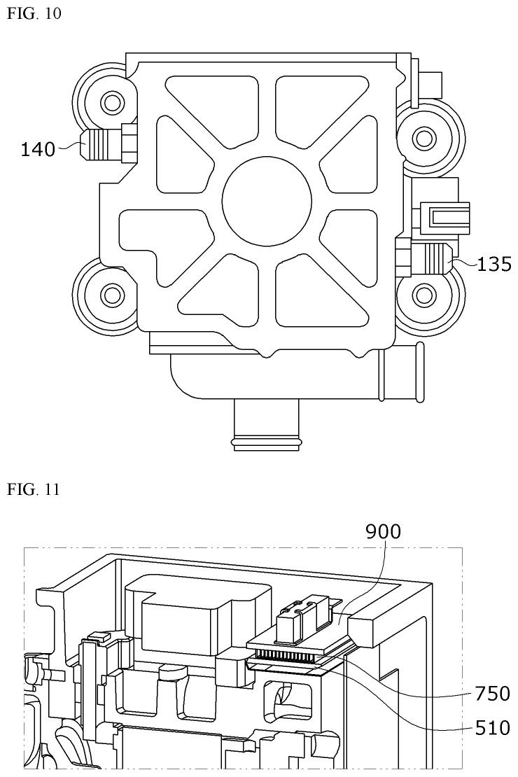

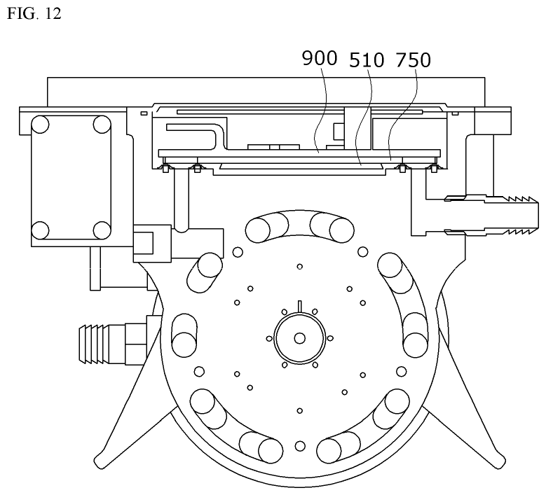

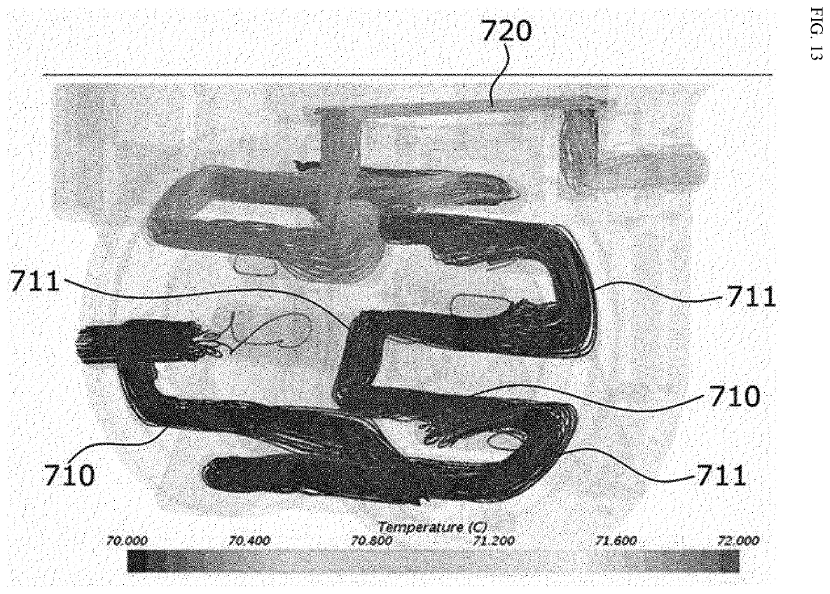

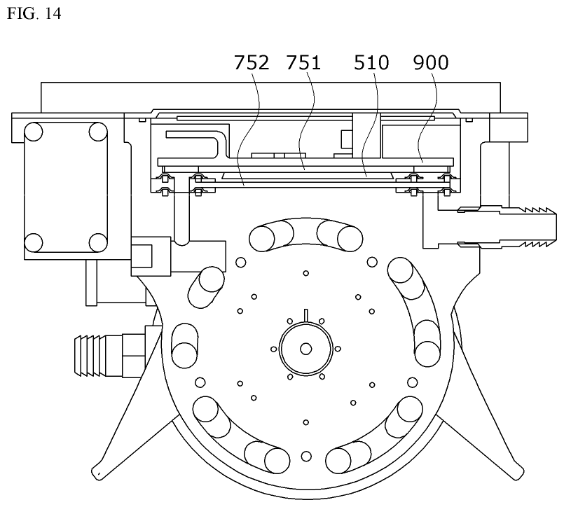

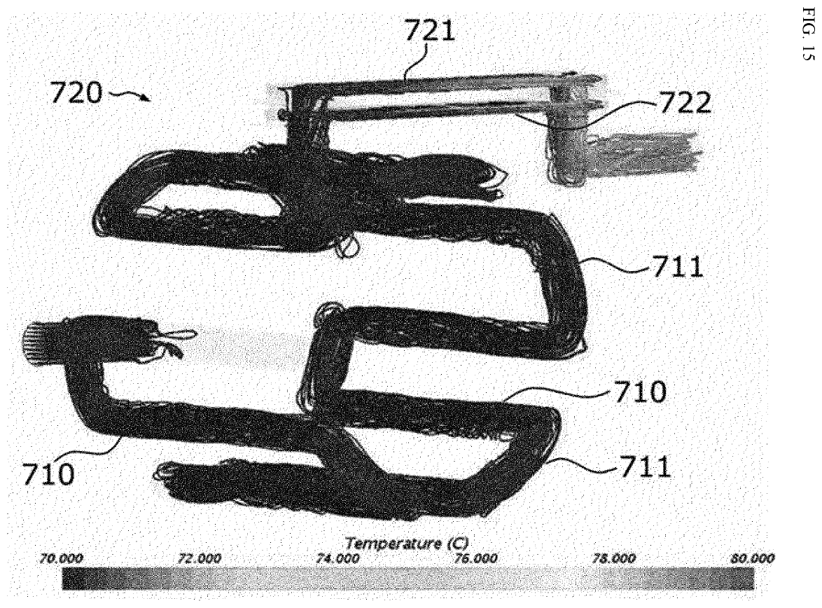

FIG. 4 is a partial cross-sectional view of an air compressor according to an embodiment of the present invention, FIG. 5 is a plan view of a housing according to an embodiment of the present invention, FIG. 6 is a partial cross-sectional view of a front portion of an air compressor according to an embodiment of the present invention, FIG. 7 is a partial cross-sectional view of a front portion of an air compressor according to an embodiment of the present invention, FIG. 8 is a view showing the positions of a first cooling flow channel and second cooling flow channel in a housing according to an embodiment of the present invention, FIG. 9 is a view showing the shape of the first cooling flow channel in FIG. 8, FIG. 10 is a view showing the inflow and outflow structure of the heat exchanging medium in FIG. 1, FIG. 11 is a view showing the internal structure of FIG. 1, FIG. 12 is a view showing a first embodiment of the cooling flow channel in FIG. 1, FIG. 13 is a view showing the flow of the heat exchanging medium in FIG. 12, FIG. 14 is a view showing a second embodiment of the cooling flow channel in FIG. 1, and FIG. 15 is a view showing the flow of the heat exchanging medium in FIG. 14.

Referring to FIGS. 4 to 15, the cooling flow channel 700 passes between the motor unit (300 in FIG. 1) and the filter unit (500 in FIG. 1). The cooling flow channel 700 absorbs heat from the motor unit 300 and the filter unit 500.

Any one selected from among air, refrigerant, and cooling water may circulate as a heat exchanging medium in the cooling flow channel 700. There are a plurality of cooling flow channels 700, and the plurality of cooling flow channels 700 may be spaced apart from each other in a circumferential direction.

The cooling flow channel 700 may include a first cooling flow channel 710 and a second cooling flow channel 720. The first cooling flow channel 710 may cool the motor unit 300. The second cooling flow channel 720 may cool the filter unit 500.

The housing 100 may include an inflow pipe 135 through which the heat exchanging medium flows in and an outflow pipe 140 through which the heat exchanging medium that has undergone heat exchange inside the housing 100 flows out.

The heat exchanging medium introduced through the inflow pipe 135 circulates in the first cooling flow channel 710 to cool the motor unit 300. A heat exchanging medium moving through the first cooling flow channel 710 may be disposed outside the motor unit 300 to absorb the heat generated from the motor unit 300.

A plurality of first cooling flow channels 710 may be provided and disposed in the axial direction of the motor unit 300. In this case, the first cooling flow channel 710 may be arranged so that the heat exchanging medium moves along the pipe.

In one embodiment, the first cooling flow channel 710 may be disposed such that one end faces the compression unit 200 and the other end faces the control board 410.

A plurality of first cooling flow channels 710 may be disposed along the outer circumferential surface of the motor unit 300, and the first cooling flow channels 710 may be connected through a connection flow channel 711. The connection flow channel 711 may alternately connect one side and the other side of the first connection flow channel 711 to connect the plurality of first cooling flow channels 710 in series. In order to efficiently cool the entire motor unit 300, the first cooling flow channel 710 and the connection flow channel 711 may be disposed so that the heat exchanging medium moving along the first cooling flow channel 710 moves in a zigzag pattern.

In one embodiment, the plurality of first cooling flow channels 710 may be arranged in parallel with the neighboring first cooling flow channels 710, and the connection flow channels 711 may be arranged perpendicular to the first cooling flow channels 710.

The second cooling flow channel 720 may cool a control unit 400. A heat exchanger 750 may be disposed in a moving line of the heat exchanging medium moving through the second cooling flow channel 720. The heat exchanger 750 may perform heat exchange with the filter unit 500, which is a component of the control unit 400. The second cooling flow channel 720 is disposed inside the heat exchanger 750 so that the heat exchanging medium introduced from the first cooling flow channel 710 moves inside the heat exchanger 750 and may absorb the heat conducted due to contact with the heat exchanger 750.

In one embodiment, the heat exchanger 750 may absorb heat from the transistor 510, which heats up hardly.

A cooling cover 900 may be disposed on an upper portion of the heat exchanger 750. The heat exchanger 750 may absorb the heat transferred through the cooling cover 900.

Referring back to FIG. 11, the heat exchanger 750 may be integrally provided with the cooling cover 900.

Since the cooling cover 900 is disposed on the heat exchanger 750, in a state where the cooling cover 900 and the heat exchanger 750 are integrally provided, a phenomenon in which the cooling cover 900 vibrates due to external force may be reduced. The cooling cover 900 and the heat exchanger 750 may also be integrally formed through injection molding. In addition, the cooling cover 900 and the heat exchanger 750 may be coupled through an adhesive member such as an adhesive.

The second cooling flow channel 720 may be disposed behind the motor unit 300. Through this arrangement, a space can be formed inside the drive housing 120, so that a space capable of accommodating parts for the control unit can be secured.

In addition, the first cooling flow channel 710 and the second cooling flow channel 720 are connected in series, and the first cooling flow channel 710 and the second cooling flow channel 720 may have an overlapping area.

Areas of the second cooling flow channel 720 and first cooling flow channel 710 may be respectively disposed on the upper and lower portions of the filter unit 500.

The first cooling flow channel 710 may be disposed parallel to the axial direction of the motor unit 300. A plurality of first cooling flow channels 710 is disposed outside the motor unit 300 and is connected through the connection flow channel 711. The second cooling flow channel 720 is disposed to cross the first cooling flow channel 710, and the connection flow channel 711 to which the first cooling flow channel 710 is connected may be provided with an area where the second cooling flow channel 720 overlaps. Cooling efficiency may be increased through this overlapping area.

The second cooling flow channel 720 may include a second-1 cooling flow channel 721 and a second-2 cooling flow channel 722.

The second-1 cooling flow channel 721 may be disposed on the upper portion of the filter unit 500 and the second-2 cooling flow channel 722 may be disposed on the lower portion of the filter unit 500.

The second cooling flow channel 720 may have a branching structure inside the heat exchanger 750. In one embodiment, the heat exchanger 750 may include a first heat exchange passage 751 in which the second-1 cooling flow channel 721 is disposed and a second heat exchange passage 752 in which the second-2 cooling flow channel 722 is disposed.

The heat exchanging medium passing through the first cooling flow channel 710 flows into the heat exchanger 750. The heat exchanging medium flowing into the heat exchanger 750 is branched from one side of the heat exchanger 750, and moves to the first heat exchange passage 751 disposed in the second-1 cooling flow channel 721 and the second heat exchange passage 752 disposed in the second-2 cooling flow channel 722.

In one embodiment, the transistor 510 may be disposed between the first heat exchange passage 751 and the second heat exchange passage 752. The second-1 cooling flow channel 721 and second-2 cooling flow channel 722 disposed on the upper and lower portions of the transistor 510 respectively may absorb the heat generated from the transistor 510 to increase cooling efficiency.

In addition, the upper side of the second-2 cooling flow channel 722 may contact the transistor 510 to cool the transistor 510, and the lower side of the second-2 cooling flow channel 722 may contact the motor unit 300 to absorb the heat generated from the motor unit 300 and cool the motor unit 300, thereby improving cooling efficiency.

The number of second cooling flow channels 720 may reduce the overall temperature of the compression unit 200 by adjusting the differential pressure of the cooling flow channels of the entire compressor with the number of cooling flow channels passing through the transistor 510.

Referring to FIGS. 12 to 15, the cooling flow paths of the entire air compressor passes through the compression unit 200 to the control unit 400, and become contact surfaces with the filter unit 500 of the control unit 400 and the transistor 510 among the components of the filter unit 500. In this case, the first cooling flow channel 710 for cooling the compression unit 200 and the second cooling flow channel 720 for cooling the control unit 400 may be connected in series to form a unified cooling flow channel.

In addition, durability of the transistor 510 against heat may be increased through direct contact with the transistor 510 that generates a lot of heat.

In the case where the heat exchanger 750 shown in FIGS. 12 and 13 is arranged to cool one side of the transistor 510, even if only one side is cooled, an overlapping area is provided to satisfy the guaranteed temperature for cooling the transistor, so that cost is reduced and assembility can be improved.

In the case where the heat exchanger 750 shown in FIGS. 14 and 15 is arranged to cool both sides of the transistor 510, it can be seen that the cooling efficiency is further increased in the case of cooling both sides, compared to the case of colling one side.

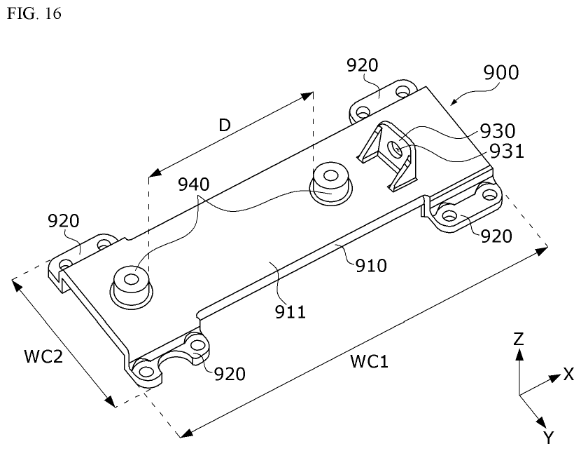

FIG. 16 is a perspective view of a cover according to an embodiment of the present invention.

Referring to FIG. 16, the cooling cover 900 may include a body 910, a fixing unit 920, a connector fixing unit 930, and a resistor fixing unit 940.

The body 910 may be disposed on the upper side of the transistor 510 to cover at least a portion of the upper and side surfaces of the transistor 510. In this case, the body 910 can absorb the heat generated from the transistor 510 to prevent the transistor 510 from overheating. The body 910 may include at least one of aluminum, synthetic resin, and steel.

The fixing unit 920 is plural, and each fixing unit 920 may extend from an edge of the body 910. The plurality of fixing units 920 may be integrally formed with the body 910 and made of the same material as the body 910. In this case, the plurality of fixing units 920 may be coupled to the first housing (120 in FIG. 2) by fastening bolts.

The connector fixing unit 930 may be disposed on the upper surface 911 of the body 910. Also, the connector fixing unit 930 may fix the connector unit 800 passing through the upper side of the cooling cover 900. The connector fixing unit 930 protrudes upward from the upper surface of the body 910, and may include a fixing hole 931 into which the fixing clip 830 is inserted. In this case, the end of the fixing clip 830 is inserted into the fixing hole 931 so that the movement can be fixed.

The resistor fixing unit 940 may be fastened to the discharge resistor 1000. More specifically, the resistor fixing unit 940 may be fastened to the first fixing member 1100 for fixing the discharge resistor 1000.

The resistor fixing unit 940 is plural, and the plurality of resistor fixing units 420 may be spaced apart in the first direction (X-axis direction). In this case, the discharge resistor 1000 may be disposed between the plurality of resistor fixing units 940 spaced apart from each other. In this case, a separation distance D between the plurality of resistor fixing units 940 in the first direction (X-axis direction) may be greater than the width of the discharge resistor 100.

The cooling cover 900 may be a rectangular member. The cooling cover 900 may have a width WC1 in the first direction (X-axis direction) greater than a width WC2 in the second direction (Y-axis direction).

Although the above description has been made with reference to the preferred embodiments of the present invention, those skilled in the art will understand that the present invention can be variously changed and modified within the scope not departing from the spirit and scope of the present invention described in the claims below.

### DESCRIPTION OF REFERENCE NUMERAL

100: housing
101: rotating shaft
110: impeller housing
120: driving housing
135: inflow pipe
140: outflow pipe
200: compression unit
300: motor unit
310: rotor
320: stator
400: control unit
410: control board
500: filter unit
510: transistor
600: bus bar assembly
620: bus bar fixing member
700: cooling flow channel
710: first cooling flow channel
711: connection flow channel
720: second cooling flow channel
721: second-1 cooling flow channel
722: second-2 cooling flow channel
750: heat exchanger
751: first heat exchange passage
752: second heat exchange passage
800: connector unit
900: cooling cover

What is claimed is:

1. An air compressor comprising:
a housing;
a rotating shaft disposed inside the housing;
a compression unit that is connected to the rotating shaft and compresses and discharges introduced air;
a motor unit that drives the rotating shaft;
a control board that controls the motor unit; and
a filter unit that filters noise of external power and supplies the external power to the control board,
wherein the housing includes a first cooling flow channel for cooling the motor unit and a second cooling flow channel for cooling the filter unit, and the first cooling flow channel communicates with the second cooling flow channel.

2. The air compressor of claim 1, wherein the first cooling flow channel is disposed in an axial direction of the motor unit.

3. The air compressor of claim 1, wherein the first cooling flow channel is provided in plurality.

4. The air compressor of claim 3, wherein the plurality of first cooling flow channels is connected through a connection passage,
the connection passage is disposed so that a heat exchange medium moving in the first cooling flow channel moves in a zigzag pattern.

5. The air compressor of claim 1, wherein the second cooling flow channel is disposed along a radial direction of the motor unit.

6. The air compressor of claim 5, wherein the second cooling flow channel performs heat exchange with a configuration of the filter unit.

7. The air compressor of claim 6, wherein the second cooling flow channel is disposed inside a heat exchanger.

8. The air compressor of claim 7, wherein heat exchange is performed on at least one surface of the heat exchanger.

9. The air compressor of claim 5, wherein the second cooling flow channel is disposed behind the motor unit.

10. The air compressor of claim 1, wherein the first cooling flow channel and the second cooling flow channel are connected in series.

11. The air compressor of claim 10, wherein areas of the second cooling flow channel and first cooling flow channel are respectively disposed on upper and lower portions of the filter unit.

12. The air compressor of claim 8, wherein the filter unit includes a transistor,
the heat exchanger performs heat exchange with the transistor.

13. The air compressor of claim 8, wherein the second cooling flow channel includes a second-1 cooling flow channel and a second-2 cooling flow channel.

14. The air compressor of claim 13, wherein the second-1 cooling flow channel is disposed on an upper portion of the filter unit, and the second-2 cooling flow channel is disposed on a lower portion of the filter unit.

15. The air compressor of claim 14, wherein one side of the heat exchanger performs heat exchange with the filter unit, and the other side of the heat exchange performs heat exchange with the motor unit.

16. The air compressor of claim 15, wherein the heat exchanger includes a first heat exchange passage in which the second-1 cooling flow channel is disposed and a second heat exchange passage in which the second-2 cooling flow channel is disposed.

17. The air compressor of claim 1, wherein the housing includes an impeller housing and a drive housing,
the motor unit is disposed in the driving housing,
accommodating units are formed on both sides of an upper portion of the motor unit, and the filter unit is disposed in the accommodating units.

18. The air compressor of claim 17, wherein at least one of the accommodating units is connected to a connector unit.

19. The air compressor of claim 1, wherein the motor unit includes a rotor disposed outside the rotating shaft and a stator disposed on outside the rotating shaft,
the stator includes teeth and a shoe disposed at ends of the teeth,
at an end of the shoe facing the rotor, a groove is disposed to be biased from a center line of the teeth.

20. The air compressor of claim 7, comprising a cooling cover disposed on the heat exchanger,
wherein the cooling cover and the heat exchanger are integrally provided.
